(19) United States
(12) Patent Application Publication
(10) Pub. No.: US 2009/0005284 A1
(43) Pub. Date: Jan. 1, 2009

(54) Cleaning Product for Rugs, Fabrics and Carpets

(76) Inventors: Olivier Denis Chretien, La Combe De Lancey (FR); Alain Michel Delaite, Limons (FR); Bernard Gilbert Papavoine, Vichy (FR)

Correspondence Address: Ralph A. Dowell of DOWELL & DOWELL P.C., 2111 Eisenhower Ave, Suite 406, Alexandria, VA, 22314, US

(21) Appl. No.: 12/087,483

(22) PCT Filed: Jan. 16, 2007
(86) PCT No.: PCT/FR2007/000071

§ 371 Date: Jul. 8, 2008

(30) Foreign Application Priority Data
Jan. 24, 2006 (FR) 0600795

(51) Int. Cl. C11D 3/06; C11D 1/74

(52) U.S. Cl. 510/280

(57) ABSTRACT

The invention relates to an aqueous base formulation for cleaning rugs, fabrics, carpets, and the like. The formulation is composed of seventy-eight point five percent water, to which is added tetrapotassium pyrophosphate at ten percent of the formulation. A nonionic surfactant, ethoxylated glycery) ricinoleate, is then added at three percent. An isopropyl alcohol is then added at three percent. A fifth product, propylene carbonate, is introduced at five percent. Finally, sodium cumene sulphonate is added at zero point five percent. All these products are inserted with mechanized stirring so as to allow complete homogenization. There are no side effects for the user and the environment.

The present invention relates to a formulation for cleaning rugs, fabrics and carpets which are not dangerous to the user or the environment.

This formulation is formulated on an aqueous base.

Currently, the commercially available products are formulated with starting materials that are dangerous to humans and to the environment.

The formulation according to the invention makes it possible to remedy this drawback.

According to a first characteristic, it in fact comprises a part of water representing seventy-eight point five percent (78.5%) of the formula.

Tetrapotassium pyrophosphate (K₄P₂O₇) is then incorporated, representing ten percent (10%) of the formula.

This said tetrapotassium pyrophosphate is a clarifying dispersing agent.

Ethoxylated glyceryl ricinoleate is then incorporated, representing three percent (3%) of the formula.

This said ethoxylated glyceryl ricinoleate is a nonionic surfactant.

Isopropyl alcohol is then introduced into the formulation at three percent (3%) of the formula (solvent), always with constant stirring.

Propylene carbonate (C₄H₆O₃) is then incorporated, representing five percent (5%) of the formula (sequestering agent).

Sodium cumene sulfonate (hydrotrope) ((CH₃)₂—CH—C₆H₄—SO₃Na) is then introduced, representing zero point five percent (0.5%).

The stirring time for each product will be ten minutes, except for the sodium cumene sulfonate, which will be a minimum of twenty-five minutes.

The stirring speed will be three hundred rpm, with a helicoidal propeller comprising a minimum of four blades, having a diameter and a drive power corresponding to the volume of the tank used.

The objective of the invention is to produce a formulation for cleaning rugs, fabrics, carpets and other supports, on an aqueous base without dangerous material.

In accordance with the invention, this objective is achieved by mixing the starting materials mentioned in the formulation, creating a molecular, inertia, thus giving a cleaning product having a wetting and sequestering capacity of very good quality.

This formulation is biodegradable and not harmful to users or the environment.

1) An aqueous base chemical formulation for cleaning rugs, fabrics, carpets and the like, characterized in that it is composed, by weight:
of 78.5% water (may be used between 48% and 97.4%);
of tetrapotassium pyrophosphate at 10%, acting as a clarifying dispersing agent (may be used between 1% and 25%);
of ethoxylated glyceryl ricinoleate at 3%, acting as a nonionic surfactant (may be used between 0.5% and 10%);
of isopropyl alcohol at 3%, acting as a solvent (may be used between 0.5% and 5%);
of propylene carbonate at 5%, acting as a sequestering and wetting agent (may be used between 0.5% and 10%);
of sodium cumene sulfonate at 0.5%, acting as a hydrotrope (may be used between 0.1% and 2%).

2) A method for preparing the formulation as claimed in the preceding claim, characterized in that, with stirring using a mechanized propeller from the beginning of the preparation in order to allow complete homogenization, tetrapotassium pyrophosphate (K₄P₂O₇) is incorporated into the water.
Ethoxylated glyceryl ricinoleate is then incorporated.
Isopropyl alcohol is then introduced into the formulation, always with constant stirring.
Propylene carbonate (C₄H₆O₃) is then incorporated.
Sodium cumene sulfonate ((CH₃)₂—CH—C₆H₄—SO₃Na) is then introduced.
The stirring time for each product will be ten minutes, except for the sodium cumene sulfonate, which will be a minimum of twenty-five minutes.
The stirring speed will be six hundred rpm with a helicoidal propeller comprising a minimum of four blades, having a diameter and a drive power corresponding to the volume of the tank used.

3) The use of the formulation as claimed in claim 1, for cleaning rugs, fabrics, carpets and other supports, in complete safety for users and the environment.
The invention relates to an aqueous base formulation for cleaning rugs, fabrics, carpets, and the like.
The formulation is composed of seventy-eight point five percent water, to which is added tetrapotassium pyrophosphate at ten percent of the formulation.
A nonionic surfactant, ethoxylated glyceryl ricinoleate, is then added at three percent.
An isopropyl alcohol is then added at three percent.
A fifth product, propylene carbonate, is introduced at five percent.
Finally, sodium cumene sulfonate is added at zero point five percent.
All these products are inserted with mechanized stirring so as to allow complete homogenization.
There are no side effects for the user and the environment.
